(19) United States
(12) Patent Application Publication
(10) Pub. No.: US 2025/0137595 A1
(43) Pub. Date: May 1, 2025

(54) APPARATUS, SYSTEM AND METHOD FOR CONTROLLING A TEMPERATURE OF HYDROGEN TANK

(71) Applicants: Hyundai Motor Company, Seoul (KR); Kia Corporation, Seoul (KR)

(72) Inventors: Jeong Hwan Hong, Hwaseong-si (KR); Seok Hyeon Park, Jeollanam-do (KR); Kang Soo Bae, Suwon-si (KR)

(21) Appl. No.: 18/677,324

(22) Filed: May 29, 2024

(30) Foreign Application Priority Data
Oct. 27, 2023 (KR) 10-2023-0145796

(51) Int. Cl. F17C 13/02

(52) U.S. Cl. CPC F17C 13/026; F17C 2221/012; F17C 2250/032; F17C 2250/0439; F17C 2250/0689; F17C 2270/0168; F17C 2270/0184

(57) ABSTRACT

The present disclosure relates to a hydrogen tank temperature control apparatus, system, and method. An example embodiment of the present disclosure provides a hydrogen tank temperature control apparatus including an air guide between a stack cooling module configured to cool a fuel cell stack and the one or more hydrogen tanks, and a processor configured to control a temperature of the one or more hydrogen tanks by controlling one or more angles of the air guide.

### CROSS-REFERENCE TO RELATED APPLICATIONS

This application claims the benefit of Korean Patent Application No. 10-2023-0145796, filed on Oct. 27, 2023, which application is hereby incorporated herein by reference.

### TECHNICAL FIELD

The present disclosure relates to a hydrogen tank temperature control apparatus, system, and method.

### BACKGROUND

Commercial hydrogen vehicles, such as trucks, consume more hydrogen than passenger vehicles, so a large-capacity hydrogen storage system must be installed and operated in the vehicle. A hydrogen storage system for commercial hydrogen vehicles stores a high-pressure hydrogen gas in a hydrogen tank under a sub-zero condition and uses it for fuel cell operation, and is being used with a limited gas temperature range of −40 to 85° C. in accordance with regulations, such as SAE J2601.

A target use temperature of a hydrogen gas is adjusted according to charging and usage on the basis of thermodynamic laws and gas equation of state based on the hydrogen tank.

In response to a case where a commercial hydrogen vehicle runs at high power for a long time, a temperature of the hydrogen tank may fall below a management temperature of −40° C. due to high hydrogen consumption, and in the instant case, a situation arises where it is impossible to drive the vehicle.

On the other hand, in response to a case where the temperature of the hydrogen tank exceeds 85° C. in the summer, a control logic is designed to block a hydrogen valve system and shut down the vehicle fuel cell, making unconditional temperature increase impossible.

### SUMMARY

The present disclosure relates to a hydrogen tank temperature control apparatus, system, and method, and more specifically, to a technique for controlling a temperature of a hydrogen tank by installing an air guide.

An example embodiment of the present disclosure can provide a hydrogen tank temperature control apparatus, system, and method, configured for solving a problem of inoperability due to a low temperature of a hydrogen tank and enabling continuous driving by raising the temperature of the hydrogen tank using hot air from a stack cooling module through adjustment of an angle of an air guide on a rear surface of the stack cooling module according to at least one of an outside air temperature, a fuel cell stack output, a hydrogen tank temperature, or a combination thereof, in a case where the hydrogen tank is at a low temperature.

An example embodiment of the present disclosure can provide a hydrogen tank temperature control apparatus, system, and method, configured for preventing a temperature of a hydrogen tank from rising by blocking hot air from a stack cooling module through adjustment of an angle of an air guide on a rear surface of the stack cooling module and for increasing vehicle driving stability by uniformly controlling the temperature between multiple hydrogen tanks according to at least one of an outside air temperature, a fuel cell stack output, a hydrogen tank temperature, or a combination thereof, in a case where the hydrogen tank is at a high temperature.

Technical advantages of the present disclosure are not necessarily limited to the advantages mentioned herein, and other technical advantages may be clearly understood by those skilled in the art.

An example embodiment of the present disclosure provides a hydrogen tank temperature control apparatus including a processor configured to control a temperature of one or more hydrogen tanks by controlling an angle of an air guide between a stack cooling module that cools a fuel cell stack and the one or more hydrogen tanks, and a storage configured to store data and algorithms driven by the processor.

In an example embodiment of the present disclosure, the processor may be configured to control the angle of the air guide by using at least one of an outside air temperature, an output of the fuel cell stack, the temperature of the one or more hydrogen tanks, or a combination thereof.

In an example embodiment of the present disclosure, the processor may be configured to move horizontally air passing through the stack cooling module to the one or more hydrogen tanks by controlling an initial air guide to 0 degrees after a vehicle starts.

In an example embodiment of the present disclosure, the processor may be configured, in response to a case where an outside air temperature is lower than a threshold, set, preset, or predetermined first reference value, to be configured to control the air guide by a selected, preset, or predetermined angle to allow the air passing through the stack cooling module to flow into a hydrogen tank which is far from the stack cooling module among the one or more hydrogen tanks.

In an example embodiment of the present disclosure, the processor may be configured in response to a case where an outside air temperature is lower than a threshold, set, preset, or predetermined first reference value, to control the air passing through the stack cooling module to flow upward into the hydrogen tank at a selected, preset, or predetermined angle by controlling the horizontal air guide upward by the selected, preset, or predetermined angle.

In an example embodiment of the present disclosure, the processor may be configured to compare an average temperature of hydrogen tanks whose distance from the stack cooling module is greater than a threshold, set, preset, or predetermined reference distance among the one or more hydrogen tanks with an average temperature of hydrogen tanks whose distance from the stack cooling module is closer than the threshold, set, preset, or predetermined reference distance among the one or more hydrogen tanks.

In an example embodiment of the present disclosure, the processor may be configured in response to a case where the average temperature of the hydrogen tanks whose distance from the stack cooling module is greater than the threshold, set, preset, or predetermined reference distance among the one or more hydrogen tanks is the same as the average temperature of the hydrogen tanks whose distance from the stack cooling module is closer than the threshold, set, preset, or predetermined reference distance among the one or more hydrogen tanks, to determine that temperatures of the one or more hydrogen tanks are uniformly controlled.

In an example embodiment of the present disclosure, the processor may be configured in response to a case where the average temperature of the hydrogen tanks whose distance from the stack cooling module is greater than the threshold, set, preset, or predetermined reference distance among the one or more hydrogen tanks is greater than the average temperature of the hydrogen tanks whose distance from the stack cooling module is closer than the threshold, set, preset, or predetermined reference distance among the one or more hydrogen tanks, to control the angle of the air guide to be greater than the selected, preset, or predetermined angle.

In an example embodiment of the present disclosure, the processor may be configured in response to a case where the average temperature of the hydrogen tanks whose distance from the stack cooling module is greater than the threshold, set, preset, or predetermined reference distance among the one or more hydrogen tanks is smaller than the average temperature of the hydrogen tanks whose distance from the stack cooling module is closer than the threshold, set, preset, or predetermined reference distance among the one or more hydrogen tanks, to control the angle of the air guide to be smaller than the selected, preset, or predetermined angle.

In an example embodiment of the present disclosure, the processor may be configured in response to a case where the outside air temperature is higher than a threshold, set, preset, or predetermined second reference value, to block the air passing through the stack cooling module from flowing into the one or more hydrogen tanks by controlling the angle of the air guide.

In an example embodiment of the present disclosure, the first reference value may be a temperature at which an output of the fuel cell stack is limited, and the second reference value is a temperature at which the fuel cell stack may be shut down.

In an example embodiment of the present disclosure, the processor may be configured to determine whether an output of the fuel cell stack is greater than a first threshold, set, preset, or predetermined reference value, and in response to a case where the output of the fuel cell stack is greater than the threshold, set, preset, or predetermined first reference value, to block the air passing through the stack cooling module from flowing into the one or more hydrogen tanks by controlling the angle of the air guide.

In an example embodiment of the present disclosure, in response to a case where the output of the fuel cell stack is equal to or smaller than the threshold, set, preset, or predetermined first reference value, to determine whether the output of the fuel cell stack is greater than a second reference value which is lower than the first reference value.

In an example embodiment of the present disclosure, the processor may be configured in response to a case where the output of the fuel cell stack is greater than the threshold, set, preset, or predetermined second reference value, to compare an average temperature of hydrogen tanks whose distance from the stack cooling module is greater than a threshold, set, preset, or predetermined reference distance among the one or more hydrogen tanks with the average temperature of the hydrogen tanks whose distance from the stack cooling module is closer than the threshold, set, preset, or predetermined reference distance among the one or more hydrogen tanks, to control the angle of the air guide according to a comparison result thereof.

An example embodiment of the present disclosure provides a system including a stack cooling module configured to cool a fuel cell stack, one or more hydrogen tanks, an air guide configured to introduce air passing through the stack cooling module into the one or more hydrogen tanks, and a hydrogen tank temperature control apparatus configured to control a temperature of the one or more hydrogen tanks by controlling an angle of the air guide between the stack cooling module and the one or more hydrogen tanks.

In an example embodiment of the present disclosure, the air guide may be configured may be provided between the stack cooling module and the one or more hydrogen tanks.

In an example embodiment of the present disclosure, the air guide may be configured to include a body and a driver provided at a center of the body to drive rotation of the body.

In an example embodiment of the present disclosure, the hydrogen tank temperature control apparatus may be configured to control the angle of the air guide by using at least one of an outside air temperature, an output of the fuel cell stack, the temperature of the one or more hydrogen tanks, or a combination thereof.

In an example embodiment of the present disclosure, the hydrogen tank temperature control apparatus may be configured in response to a case where an outside air temperature is lower than a threshold, set, preset, or predetermined first reference value, to configured to control the air guide by a selected, preset, or predetermined angle to allow the air passing through the stack cooling module to flow into a hydrogen tank taht is far from the stack cooling module among the one or more hydrogen tanks.

An example embodiment of the present disclosure provides a hydrogen tank temperature control method including determining, by a processor, an angle of an air guide between a stack cooling module that cools a fuel cell stack and one or more hydrogen tanks, controlling, by the processor, the angle of the air guide according to the determined angle of the air guide, and controlling, by the processor, a temperature of the one or more hydrogen tanks by allowing the air passing through the stack cooling module to uniformly flow into the one or more hydrogen tanks according to the angle of the air guide.

According to example embodiment of the present disclosure, it may be possible to solve a problem of inoperability due to a low temperature of a hydrogen tank and enabling a vehicle to perform continuous driving by raising the temperature of the hydrogen tank using hot air from a stack cooling module through adjustment of an angle of an air guide on a rear surface of the stack cooling module according to at least one of an outside air temperature, a fuel cell stack output, a hydrogen tank temperature, or a combination thereof, in a case where the hydrogen tank is at a low temperature.

According to example embodiment of the present disclosure, it may also be possible to prevent a temperature of a hydrogen tank from rising by blocking hot air from a stack cooling module through adjustment of an angle of an air guide on a rear surface of the stack cooling module and to increase vehicle driving stability by uniformly controlling the temperature between multiple hydrogen tanks according to at least one of an outside air temperature, a fuel cell stack output, a hydrogen tank temperature, or a combination thereof in a case where the hydrogen tank is at a high temperature.

Furthermore, various effects which may be directly or indirectly identified through the present specification may be provided.

### BRIEF DESCRIPTION OF THE DRAWINGS

The above and other features and advantages of the present disclosure can be more apparent from the following detailed description taken in conjunction with the accompanying drawings, in which:

FIG. 1 is a size view illustrating a configuration of an example hydrogen tank temperature control system according to an example embodiment of the present disclosure;

FIG. 2 is a detailed configuration diagram of an example air guide according to an example embodiment of the present disclosure;

FIG. 3 is a block diagram showing a configuration of an example hydrogen tank temperature control apparatus according to an example embodiment of the present disclosure;

FIG. 4 are views for describing a change in angle of an air guide according to an example embodiment of the present disclosure;

FIG. 5 is a flowchart showing an example hydrogen tank temperature control method according to an example embodiment of the present disclosure;

FIG. 6 are graphs for describing an example of a temperature drop in a hydrogen tank according to an example embodiment of the present disclosure; and

FIG. 7 are graphs for describing an example of ameliorating a temperature drop in a hydrogen tank according to an example embodiment of the present disclosure.

### DETAILED DESCRIPTION OF ILLUSTRATIVE EMBODIMENTS

Hereinafter, some example embodiments of the present disclosure will be described in detail with reference to example drawings. It should be noted that in adding reference numerals to constituent elements of each drawing, same constituent elements can include same reference numerals as possible even though they can be indicated on different drawings. In describing an example embodiment of the present disclosure, when it is determined that a detailed description of the well-known configuration or function associated with the example embodiment of the present disclosure may obscure the gist of the present disclosure, it can be omitted.

In describing constituent elements according to an example embodiment of the present disclosure, terms such as “first,” “second,” “A,” “B,” “(a),” and “(b)” may be used. Such terms can be merely for distinguishing the constituent elements from other constituent elements, and the nature, sequences, or orders of the constituent elements are not necessarily limited by such terms. Furthermore, all terms used herein including technical scientific terms can include the same meanings as those which are generally understood by those skilled in the technical field of the disclosure to which an example embodiment of the present disclosure pertains (e.g., those skilled in the art) unless they are differently defined. Terms defined in a generally used dictionary can be construed to have meanings matching those in the context of a related art, and shall not be construed to have idealized or excessively formal meanings unless they are clearly defined in the present specification.

In an example embodiment of the present disclosure, a technique is disclosed in which a hydrogen tank temperature control apparatus is installed with at least one air guide on a rear surface of a stack cooling module to control a temperature of a hydrogen tank by adjusting an angle of the air guide according to at least one of an outside air temperature, a fuel cell stack output, a hydrogen tank temperature, or a combination thereof.

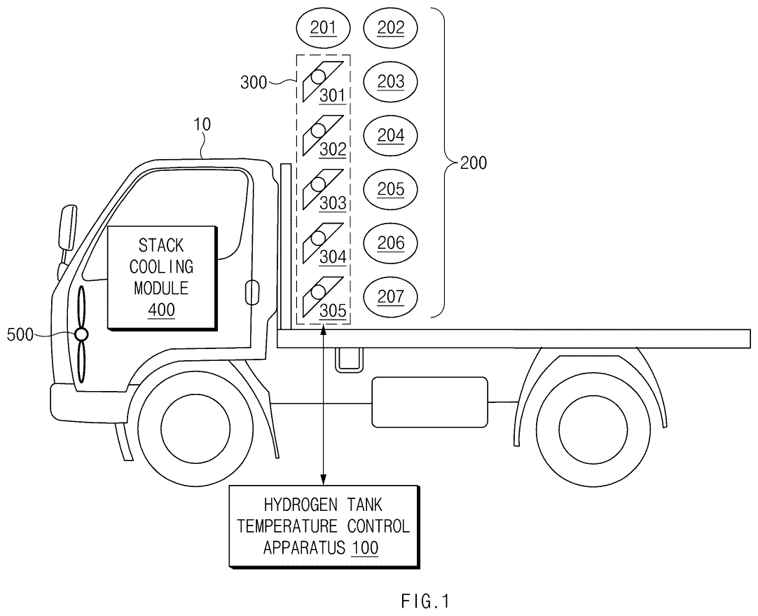

Hereinafter, various example embodiments of the present disclosure will be described in detail with reference to FIG. 1 to FIG. 7.

FIG. 1 is a block diagram showing a configuration of an example hydrogen tank temperature control system according to an example embodiment of the present disclosure.

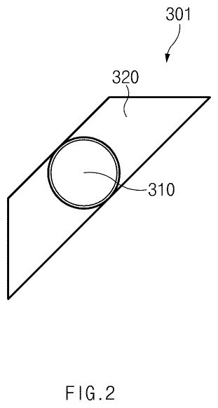

FIG. 2 is a detailed configuration diagram of an example air guide according to an example embodiment of the present disclosure.

A vehicle 10 may include a hydrogen tank temperature control apparatus 100, a hydrogen tank 200, an air guide 300, a stack cooling module 400, and a cooling fan 500. As an example case, the vehicle 10 may include a commercial hydrogen vehicle driven by hydrogen as fuel.

As illustrated in FIG. 1, the hydrogen tank temperature control apparatus 100 may be implemented inside the vehicle 10, may be integrally formed with internal control units of the vehicle, or may be implemented as a separate device to be connected to control units of the vehicle by a separate connection or communication implementation.

The hydrogen tank temperature control apparatus 100 may be configured to control a temperature of the hydrogen tank 200 by adjusting an angle of the air guide 300 according to at least one of an outside air temperature, an output of a fuel cell stack, a current temperature of the hydrogen tank 200, or a combination thereof.

The hydrogen tank 200 may include one or more hydrogen tanks 201, 202, 203, 204, 205, 206, and 207, and each of the hydrogen tanks 201, 202, 203, 204, 205, 206, and 207 may be configured to store hydrogen.

The air guide 300 may be controllably installed to be controlled by the hydrogen tank temperature control apparatus 100 to change a direction of air flow, and an angle thereof may be controlled by the hydrogen tank temperature control apparatus 100 to allow or not to export hot air from the stack cooling module 400 to the hydrogen tank 200. The air guide 300 may include one or more air guides 301, 302, 303, 304, and 305.

As illustrated in FIG. 2, the air guide 301 may include an air guide driver 310 and an air guide body 320, the air guide driver 310 may be provided with a motor as an actuator, and may be positioned in a center of the air guide body 320 to minimize space. The air guide driver 310 may be configured to control (rotate or pivot) an angle of the air guide body 320 to allow or prevent hot air from being discharged to the hydrogen tank 200.

The stack cooling module 400, which is a module for lowering a temperature of the fuel cell stack by cooling hot air of a stack battery, may be configured to lower a temperature of the hot air. To this end, the stack cooling module 400 may include a cooling rod, a coolant, etc.

The cooling fan 500 may be configured to provide external cold air to the stack cooling module 400 to lower the temperature of the hot air at a side of the stack cooling module 400.

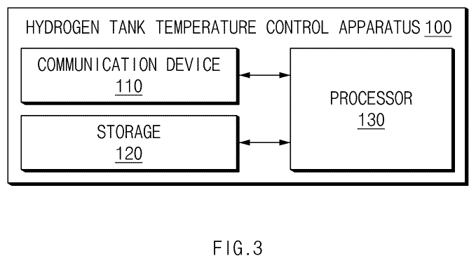

FIG. 3 is a block diagram showing a configuration of an example hydrogen tank temperature control apparatus according to an example embodiment of the present disclosure.

Referring to FIG. 3, the hydrogen tank temperature control apparatus 100 may include a communication device 110, a storage 120, and a processor 130.

The communication device 110 may be a hardware device implemented with various electronic circuits to transmit and receive signals through a wireless or wired connection, and may transmit and receive information based on in-vehicle devices and in-vehicle network communication techniques. As an example embodiment of the present disclosure, the in-vehicle network communication techniques may include Controller Area Network (CAN) communication, Local Interconnect Network (LIN) communication, flex-ray communication, and the like, for example.

As an example embodiment of the present disclosure, the communication device 110 may be configured to receive outside air temperature information and output information of the fuel cell stack from an in-vehicle device. However, in the present disclosure, an example of receiving information through in-vehicle CAN communication is disclosed, but the present disclosure is not necessarily limited thereto, and an external temperature sensor may be further provided to receive external temperature information from the external temperature sensor.

The storage 120 may be configured to store data and/or algorithms for the processor 130 to operate to equalize or adjust the temperature of the hydrogen tank 200.

For example, the storage 120 may be configured to store reference values A and B for determining the outside air temperature and reference values C and D for determining the output of the fuel cell stack, which may be selected, preset, or predetermined based on experimental values, for example.

Furthermore, the storage 120 may be configured to store external temperature information received from an in-vehicle device and to output information of the fuel cell stack.

The storage 120 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, an optical disk, or any combination thereof, for example.

The processor 130 may be electrically connected to the communication device 110, the storage 120, and the like, may electrically control each component, and may be an electrical circuit that executes software commands, thereby performing various data processing and calculations described below.

The processor 130 may process signals transferred between constituent elements of the hydrogen tank temperature control apparatus 100. The processor 130 may perform general control such that each component may normally perform a function thereof. The processor 130 may be implemented in the form of hardware, software, or a combination of hardware and software. The processor 130 may be implemented as a microprocessor, but the present disclosure is not necessarily limited thereto, and may be, e.g., an electronic control unit (ECU), a micro controller unit (MCU), or other subcontroller(s) mounted in the vehicle.

The processor 130 may be configured to control an angle of the air guide 300 between the stack cooling module 400 for lowering the temperature of the fuel cell stack and one or more hydrogen tanks 201, 202, 203, 204, 205, 206, and 207 to control or uniformly control a temperature of the one or more hydrogen tanks 201, 202, 203, 204, 205, 206, and 207.

The processor 130 may be configured to control the angle of the air guide 300 by using at least one of the outside air temperature, the output of the fuel cell stack, the temperature of the one or more hydrogen tanks 201, 202, 203, 204, 205, 206, and 207, or a combination thereof.

In response to ignition-on of the vehicle, the processor 130 may be configured to control the angle of the initial air guide 300 to 0 degrees to allow hot air from the stack cooling module 400 to move horizontally to the one or more hydrogen tanks 201, 202, 203, 204, 205, 206, and 207.

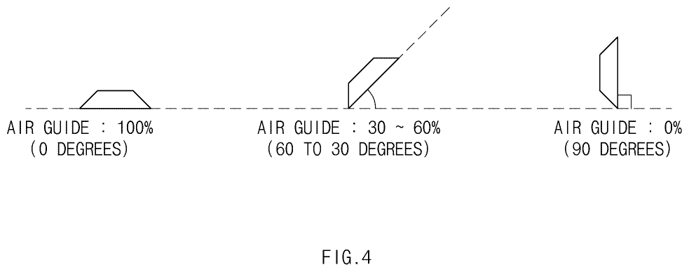

Air introduced from the outside air may pass through the stack cooling module 400 to flow into the at least one hydrogen tank 201, 202, 203, 204, 205, 206, and 207 through the air guide 300. In response to a case where the angle of the air guide 300 is 0 degrees, the air guide 300 is in a horizontal state as illustrated in FIG. 4. FIG. 4 are views for describing a change in angle of an air guide according to an example embodiment of the present disclosure.

In response to a case where the angle of the air guide 300 is 0 degrees, as illustrated in FIG. 1, hot air may flow into hydrogen tanks 205, 206, and 207 corresponding horizontally to the stack cooling module 400, and an inflow of hot air into the hydrogen tanks 201, 202, 203, and 204 positioned above the stack cooling module 400 may be less than that of the hydrogen tanks 205, 206, and 207, and thus there may be a difference between temperatures of the hydrogen tanks 205, 206, and 207 corresponding horizontally to the stack cooling module 400 and temperatures of the hydrogen tanks 201, 202, 203, and 204 positioned above the stack cooling module 400.

In response to a case where the outside air temperature is lower than a first threshold, set, preset, or predetermined reference value (e.g. −10° C.), the processor 130 may be configured to control the air guide 300 by a selected, preset, or predetermined angle (e.g., 45 degrees) such that the hot air from the stack cooling module flows into the hydrogen tanks 201, 202, 203, and 204 that are far from the stack cooling module 400 among the one or more hydrogen tanks 201, 202, 203, 204, 205, 206, and 207.

In response to the case where the outside air temperature is lower than the first threshold, set, preset, or predetermined reference value, the processor 130 may be configured to control the air guide 300 at a horizontal angle (0 degrees) upward by a selected, preset, or predetermined angle (e.g., 45 degrees) so that the hot air from the stack cooling module 400 may be controlled to flow upward into the hydrogen tanks 201, 202, 203, 204, 205, 206, and 207 at a selected, preset, or predetermined angle. As illustrated in FIG. 4, the air guide 300 may be pivoted or rotated to stand upright by 45 degrees from a horizontal state.

The processor 130 may be configured to compare an average temperature of hydrogen tanks 201, 202, 203, and 204 whose distance from the stack cooling module 400 is farther than a threshold, set, preset, or predetermined reference distance among the one or more hydrogen tanks 201, 202, 203, 204, 205, 206, and 207 with an average temperature of hydrogen tanks 205, 206, and 207 that are closer to the stack cooling module 400 than the threshold, set, preset, or predetermined reference distance among the one or more hydrogen tanks 201, 202, 203, 204, 205, 206, and 207.

Accordingly, the processor 130 may be configured to determine that the temperatures of the one or more hydrogen tanks 201, 202, 203, 204, 205, 206, and 207 are uniformly controlled in response to a case where the average temperature of hydrogen tanks 201, 202, 203, and 204 whose distance from the stack cooling module 400 is farther than the threshold, set, preset, or predetermined reference distance among the one or more hydrogen tanks 201, 202, 203, 204, 205, 206, and 207 is equal to the average temperature of hydrogen tanks 205, 206, and 207 which are closer to the stack cooling module 400 than the threshold, set, preset, or predetermined reference distance among the one or more hydrogen tanks 201, 202, 203, 204, 205, 206, and 207.

The processor 130 may be configured to control the angle of the air guide 300 to be greater than a selected, set, or predetermined angle in response to a case where the average temperature of hydrogen tanks 201, 202, 203, and 204 whose distance from the stack cooling module 400 is farther than the threshold, set, preset, or predetermined reference distance among the one or more hydrogen tanks 201, 202, 203, 204, 205, 206, and 207 is greater than the average temperature of hydrogen tanks 205, 206, and 207 that are closer to the stack cooling module 400 than the threshold, set, preset, or predetermined reference distance among the one or more hydrogen tanks 201, 202, 203, 204, 205, 206, and 207.

The processor 130 may be configured to control the angle of the air guide 300 to be smaller than the selected, set, or predetermined angle in response to a case where the average temperature of hydrogen tanks 201, 202, 203, and 204 whose distance from the stack cooling module 400 is farther than the threshold, set, preset, or predetermined reference distance among the one or more hydrogen tanks 201, 202, 203, 204, 205, 206, and 207 is smaller than the average temperature of hydrogen tanks 205, 206, and 207 which are closer to the stack cooling module 400 than the threshold, set, preset, or predetermined reference distance among the one or more hydrogen tanks 201, 202, 203, 204, 205, 206, and 207.

In response to a case where the outside air temperature is higher than a threshold, set, preset, or predetermined second reference value (e.g., 30° C.), the processor 130 may be configured to block hot air from the stack cooling module 400 from flowing into the one or more hydrogen tanks 201, 202, 203, 204, 205, 206, and 207 by controlling the angle of the air guide 300. As illustrated in FIG. 4, the angle of the air guide 300 may be 90 degrees, so the hot air from the stack cooling module 400 may not move to the one or more hydrogen tanks 201, 202, 203, 204, 205, 206, and 207.

In the instant case, the first reference value may be a temperature at which the output of the fuel cell stack is limited, and the second reference value may be a temperature at which the fuel cell stack is shut down, for example.

The processor 130 may be configured to determine whether the output of the fuel cell stack is greater than a first threshold, set, preset, or predetermined reference value (e.g., 80%), and in response to a case where the output of the fuel cell stack is greater than the first threshold, set, preset, or predetermined reference value, may block the hot air from the stack cooling module 400 from flowing into the one or more hydrogen tanks 201, 202, 203, 204, 205, 206, and 207 by controlling the angle of the air guide 300.

The processor 130 may be configured to determine whether the output of the fuel cell stack is greater than a second reference value that is lower than the first reference value in response to a case where the output of the fuel cell stack is equal to or less than the first reference value, and may be configured to compare the average temperature of hydrogen tanks 201, 202, 203, and 204 whose distance from the stack cooling module 400 is farther than the threshold, set, preset, or predetermined reference distance among the one or more hydrogen tanks 201, 202, 203, 204, 205, 206, and 207 with the average temperature of hydrogen tanks 205, 206, and 207 that are closer to the stack cooling module 400 than the threshold, set, preset, or predetermined reference distance among the one or more hydrogen tanks 201, 202, 203, 204, 205, 206, and 207 in response to a case where the output of the fuel cell stack is greater than the second reference value, to control the air guide 300 according to a comparison result thereof.

The processor 130 may be configured to determine that the temperatures of the one or more hydrogen tanks 201, 202, 203, 204, 205, 206, and 207 are uniformly controlled in response to a case where the output of the fuel cell stack is greater than the second reference value, and the average temperature of hydrogen tanks 201, 202, 203, and 204 whose distance from the stack cooling module 400 is farther than the threshold, set, preset, or predetermined reference distance among the one or more hydrogen tanks 201, 202, 203, 204, 205, 206, and 207 is equal to the average temperature of hydrogen tanks 205, 206, and 207 which are closer to the stack cooling module 400 than the threshold, set, preset, or predetermined reference distance among the one or more hydrogen tanks 201, 202, 203, 204, 205, 206, and 207.

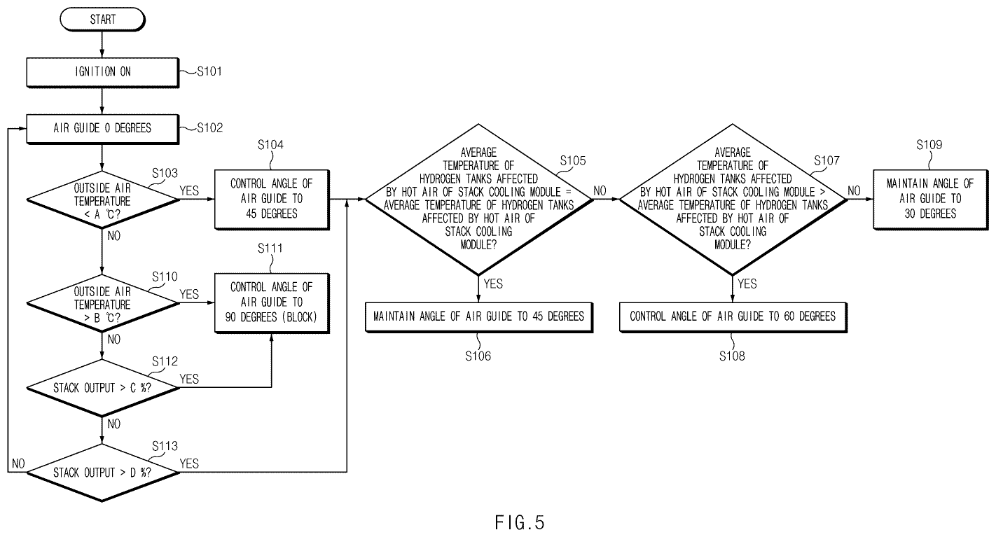

Hereinafter, a hydrogen tank temperature control method according to an example embodiment of the present disclosure will be described with reference to FIG. 5. FIG. 5 is a flowchart showing an example hydrogen tank temperature control method according to an example embodiment of the present disclosure.

Hereinafter, it is assumed that the hydrogen tank temperature control apparatus 100 of the of FIG. 1 performs processes of FIG. 5, as an example embodiment implementation. In addition, in the description of FIG. 5, operations described as being performed by a system may be understood as being controlled by the processor 130 of the hydrogen tank temperature control apparatus 100, for example.

Referring to FIG. 5, after the vehicle starts (operation S101), the hydrogen tank temperature control apparatus 100 may be configured to set an angle of the initial air guide 300 to 0 degrees (operation S102). In response to a case where the angle of the air guide 300 is 0 degrees, as illustrated in FIG. 4, by positioning the air guide 300 horizontally, hot air from the stack cooling module 400 may be configured to move toward the hydrogen tanks 205, 206, and 207 through the air guide 300. However, in response to the case where the angle of the air guide 300 is 0 degrees, it may be difficult for hot air to move toward the upper hydrogen tanks 201, 202, 203, and 204. Furthermore, air resistance of the vehicle may be minimized by setting the angle of the initial air guide 300 to 0 degrees. However, an example of setting the angle of the initial air guide 300 to 0 degrees is disclosed, but the present disclosure is not limited thereto, and the angle of the initial air guide 300 may be set to other angles according to an initial outside air temperature or a known tank temperature. For example, in response to a case where the outside air temperature is below a threshold, set, preset, or predetermined reference value A, the angle of the initial air guide 300 may be set to 45 degrees. Furthermore, upon starting the engine, the angle of the air guide 300 may be set based on a temperature of each tank.

Thereafter, the hydrogen tank temperature control apparatus 100 may be configured to determine whether the outside air temperature is below a threshold, set, preset, or predetermined reference value A (operation S103), and in response to a case where the outside air temperature is below the threshold, set, preset, or predetermined reference value A, by controlling the angle of the air guide 300 to 45 degrees, for example, the air guide 300 may be controlled at an angle so that hot air moves further toward the upper hydrogen tanks 201, 202, 203, and 204 (operation S104).

In the instant case, the hydrogen tank temperature control apparatus 100 may be configured to receive outside air temperature information from an in-vehicle device, such as a vehicle control unit (VCU), for example.

Next, the hydrogen tank temperature control apparatus 100 may be configured to determinate an average temperature of the hydrogen tanks affected by the hot air of the stack cooling module 400, that is, the hydrogen tanks 204, 205, and 206 adjacent to the stack cooling module 400, and may be configured to determines an average temperature of the hydrogen tanks which are not affected by the hot air of the stack cooling module 400, that is, the hydrogen tanks 201, 202, 203, and 204 which are more distant from the stack cooling module 400, to determine whether the average temperature of the hydrogen tanks 204, 205, and 206 adjacent to the stack cooling module 400 and the average temperature of the hydrogen tanks 201, 202, 203, and 204 more distant from the stack cooling module 400 are the same (operation S105).

In response to a case where the average temperature of hydrogen tanks 204, 205, and 206 adjacent to the stack cooling module 400 and the average temperature of hydrogen tanks 201, 202, 203, and 204 distant from the stack cooling module 400 are the same, the hydrogen tank temperature control apparatus 100 may be configured to maintain the angle of the air guide 300 at 45 degrees because the hydrogen tanks 201, 202, 203, 204, 205, 206, and 207 are being heated uniformly (operation S106).

On the other hand, in response to a case where the average temperature of hydrogen tanks 204, 205, and 206 adjacent to the stack cooling module 400 and the average temperature of hydrogen tanks 201, 202, 203, and 204 more distant from the stack cooling module 400 are not the same, the hydrogen tank temperature control apparatus 100 may be configured to determine whether the average temperature of hydrogen tanks 204, 205, and 206 adjacent to the stack cooling module 400 is greater than the average temperature of hydrogen tanks 201, 202, 203, and 204 distant from the stack cooling module 400 (operation S107).

Accordingly, in response to a case where the average temperature of hydrogen tanks 204, 205, and 206 adjacent to the stack cooling module 400 is greater than the average temperature of hydrogen tanks 201, 202, 203, and 204 distant from the stack cooling module 400, the hydrogen tank temperature control apparatus 100 may be configured to control the angle of the air guide 300 to 60 degrees to further erect the air guide 300 in a right angle direction, allowing hot air to move more upward (operation S108).

On the other hand, in response to a case where the average temperature of hydrogen tanks 204, 205, and 206 adjacent to the stack cooling module 400 is smaller than the average temperature of hydrogen tanks 201, 202, 203, and 204 more distant from the stack cooling module 400, to uniformly raise the temperature of the hydrogen tanks 201, 202, 203, 204, 205, 206, and 207 in a state where the hydrogen tanks 201, 202, 203, and 204, which are far from the stack cooling module 400, are sufficiently heated, the hydrogen tank temperature control apparatus 100 may be configured to control the angle of the air guide 300 to 30 degrees to further lower the air guide 300 in the horizontal direction, allowing the hot air to move more downward (operation S109).

In operation S103, in response to a case where the outside air temperature is greater than the threshold, set, preset, or predetermined reference value A, the hydrogen tank temperature control apparatus 100 may be configured to determine whether the outside air temperature is greater than a threshold, set, preset, or predetermined reference value B (operation S110). In the instant case, the reference values A and B for determining the outside air temperature may be determined in advance based on experimental values, for example. The reference value A may be a sub-zero temperature (e.g., −10° C.), and the reference value B may be an image temperature (e.g., 30° C.).

Accordingly, the hydrogen tank temperature control apparatus 100 may be configured to perform adjustment of the air guide after hot air is generated in response to a case where an output of the fuel cell stack is above a certain level in a state where the outside air temperature is room temperature (greater than A and smaller than B). The hydrogen tank temperature control apparatus 100 may be configured to determine that it is winter to heat the hydrogen tanks 201, 202, 203, 204, 205, 206, and 207 through the air guide 300 in response to a case where the outside air temperature is lower than the reference value A, and may configured to determine that it is summer to block the movement of the hot air to the hydrogen tanks 201, 202, 203, 204, 205, 206, and 207 through the air guide 300 in response to a case where the outside air temperature is higher than the reference value B.

In response to a case where the outside air temperature is greater than the threshold, set, preset, or predetermined reference value B, the hydrogen tank temperature control apparatus 100 may be configured to control the angle of the air guide 300 to 90 degrees so that the air guide 300 is erected at a right angle, preventing the hot air from the stack cooling module 400 from moving to the hydrogen tanks 201, 202, 203, 204, 205, 206, and 207 (operation S111). That is, in response to a case where the outside air temperature is greater than the threshold, set, preset, or predetermined reference value B, the hot air can be blocked using the air guide 300 to prevent the temperature of the hydrogen tanks 201, 202, 203, 204, 205, 206, and 207 from increasing further. Furthermore, in response to a case where the angle of air guide 300 becomes 90 degrees, the hot air from the stack cooling module 400 may rise vertically to be discharged into the atmosphere so that a temperature effect on the hydrogen tanks 201, 202, 203, 204, 205, 206, and 207 may be minimized.

In response to a case where the outside air temperature is below the threshold, set, preset, or predetermined reference value B in the operation S110, the hydrogen tank temperature control apparatus 100 may be configured to determine whether the output of the fuel cell stack is greater than the threshold, set, preset, or predetermined reference value C (operation S112). The hydrogen tank temperature control apparatus 100 may be configured to receive output information of the fuel cell stack from an in-vehicle device, such as a fuel cell control unit (FCU), for example. The output information of the fuel cell stack can refer to voltage information from a fuel cell outputted for vehicle driving.

As the output of the fuel cell stack increases, the temperature of the hot air in the stack cooling module 400 may increase, and thus the temperature of the hydrogen tanks 201, 202, 203, 204, 205, 206, and 207 may increase, and accordingly, the hydrogen tank temperature control apparatus 100 may be configured to control the angle of the air guide 300 to 90 degrees for the air guide 300 to be erected at a right angle, preventing the hot air from the stack cooling module 400 from moving to the hydrogen tanks 201, 202, 203, 204, 205, 206, and 207 (operation S111).

On the other hand, the hydrogen tank temperature control apparatus 100 may be configured to determine whether the output of the fuel cell stack is less than or equal to the threshold, set, preset, or predetermined reference value C and greater than the reference value D (operation S113).

In response to a case where the output of the fuel cell stack is equal to or smaller than the threshold, set, preset, or predetermined reference value C and greater than the reference value D, the hydrogen tank temperature control apparatus 100 may be configured to perform operations S105 to S109 described above.

In response to a case where the output of the fuel cell stack is equal to or greater than the threshold, set, preset, or predetermined reference value C and equal to or smaller than the reference value D, the hydrogen tank temperature control apparatus 100 may be configured to control the angle of the air guide to 90 degrees (operation S111) or to 0 degrees (operation S102). In the instant case, the reference values C and D for determining the output of the fuel cell stack may be determined in advance based on experimental values, for example. The reference value C (e.g., 80%) may be a higher value than the reference value D (e.g., 10%). For example, in response to a case where the output of the fuel cell stack exceeds 80% of the total, the angle of the air guide 300 may be controlled to 90 degrees to block an inflow of hot air (operation S111). Furthermore, in response to a case where the output of the fuel cell stack exceeds 10% of the total output, the angle of the air guide 300 may be determined and controlled according to a current temperature of the hydrogen tank (operations S105 to S109).

Accordingly, the hydrogen tank temperature control apparatus 100 may have a variable temperature of hot air according to the output of the fuel cell stack, so supercooling or overheating of the hydrogen tanks 201, 202, 203, 204, 205, 206, and 207 may be prevented through the air guide according to an output range of the fuel cell stack.

FIG. 5 illustrates an example in which angles of a plurality of air guides 301, 302, 303, 304, and 305 are adjusted together, but the present disclosure is not necessarily limited thereto, and angles of each of the air guides 301, 302, 303, 304, and 305 may be adjusted differently, in subgroups, or independently, for example.

For example, in response to a case where the outside air temperature is lower than the threshold, set, preset, or predetermined reference value A, the hydrogen tank temperature control apparatus 100 may be configured to maintain angles of the air guides 303, 304, and 305 adjacent to the stack cooling module 400 at 0 degrees, and may be configured to control the angles of the air guides 301, 302, and 303, which are more separated from the stack cooling module 400, to 45 degrees so that hot air may discharged upward at a temperature of 45 degrees, raising the temperature of the upper hydrogen tanks 201, 202, 203, and 204, so the temperature of the hydrogen tanks 201, 202, 203, 204, 205, 206, and 207 may be raised uniformly.

Furthermore, in FIG. 5, an example is described where the hydrogen tanks 201, 202, 203, and 204 are positioned farther from the stack cooling module 400, and the hydrogen tanks 205, 206, and 207 are positioned closer to the stack cooling module 400 among the hydrogen tanks 201, 202, 203, 204, 205, 206, and 207 as illustrated in FIG. 1, but the angle of the air guide 300 may be adjusted flexibly by distinguishing between the hydrogen tanks which are greatly affected by hot air and hydrogen tanks that are less affected by hot air according to a position change of the hydrogen tanks 201, 202, 203, 204, 205, 206, and 207.

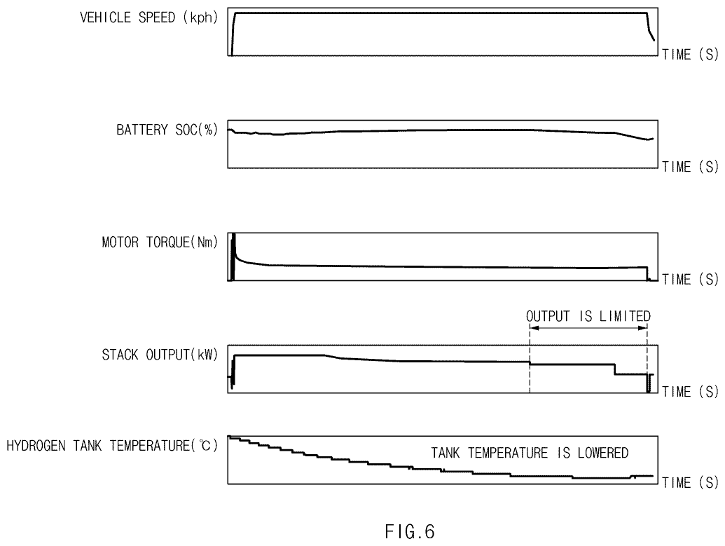

FIG. 6 are graphs for describing an example of a temperature drop in a hydrogen tank according to an example embodiment of the present disclosure.

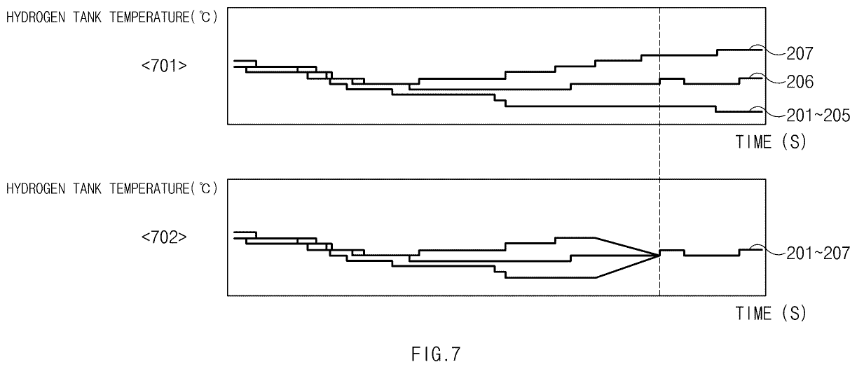

FIG. 7 are graphs for describing an example of ameliorating a temperature drop in a hydrogen tank according to an example embodiment of the present disclosure.

Referring to FIG. 6, in response to a case where a vehicle is started to drive, the vehicle drives at a constant speed. As the vehicle drives, a state of charge (SOC) of a battery is consumed, motor torque is outputted, and an output of the fuel cell stack is generated. In the instant case, a temperature of the hydrogen tank decreases as hydrogen is consumed by the driving of the vehicle.

In response to a case where the temperature of the hydrogen tank falls below a certain temperature, the output of the fuel cell stack can be limited for vehicle safety, making driving of the vehicle impossible.

The output of the fuel cell stack can be limited based on the temperature of the hydrogen tank.

For example, the output of the fuel cell stack can be outputted at 100% until the temperature of the hydrogen tank drops to −35° C. In response to a case where the temperature of the hydrogen tank falls below −40° C., it can be set to output 10% of the output of the fuel cell stack. Accordingly, with an embodiment of the present disclosure, the temperature of the hydrogen tank may be increased with hot air from the stack cooling module 400 to prevent deterioration of the output of the fuel cell stack.

Conversely, in response to a case where the temperature of the hydrogen tank becomes higher than 85° C., a valve system may be blocked and fuel cells may be shut down to ensure vehicle operation stability. In the instant case, according to an embodiment of the present disclosure, it may be possible to block hot air from the stack cooling module 400 from flowing into the hydrogen tank.

Referring to a view 701 in FIG. 7, it is illustrated that the hydrogen tanks 201, 202, 203, 204, 205, 206, and 207 each can have a difference in temperature decrease.

As illustrated in FIG. 1, among the hydrogen tanks 201, 202, 203, 204, 205, 206, and 207, the hydrogen tanks 202, 203, 204, 205, 206, and 207 may be arranged in a straight line, the hydrogen tank 201 may be positioned next to the hydrogen tank 202, and the hydrogen tanks 205, 206, and 207 may be affected by the hot air from the stack cooling module 400.

The stack cooling module 400 is a module for cooling hot air, and the hot air may pass therethrough, and thus the temperature of the hydrogen tanks 205, 206, and 207 adjacent to the stack cooling module 400 may increase more compared to the hydrogen tanks 202, 203, and 204 which are not adjacent to the stack cooling module 400.

In the view 701, it is illustrated that temperatures of the hydrogen tanks 201, 202, 203, 204, and 205 are similar, a temperature of the hydrogen tank 206 is higher than temperatures of the hydrogen tanks 201, 202, 203, 204, and 205, and a temperature of the hydrogen tank 207 closest to the stack cooling module 400 is higher than a temperature of the hydrogen tank 206.

In a view 702, it is illustrated that the temperatures of the hydrogen tanks 201, 202, 203, 204, 205, 206, and 207 can be controlled almost uniformly by controlling the hot air from the stack cooling module 400 to better flow into the hydrogen tanks 202, 203, and 204 that are farther from the stack cooling module 400 through adjustment of the angle(s) of the air guide 300.

Accordingly, according to an embodiment of the present disclosure, the temperature of the hydrogen tank 200 may be increased by heating the low-temperature hydrogen tank 200 through hot air that has passed through the stack cooling module 400, to prevent the output of the fuel cell stack from being limited due to a temperature drop of the hydrogen tank 200, enabling the vehicle to continuously drive.

Furthermore, the temperature of the hydrogen tanks 201, 202, 203, 204, 205, 206, and 207 may be uniformly controlled by adjusting the angle(s) of the air guide 300.

The above description is merely illustrative of technical ideas of the present disclosure, and those skilled in the art to which the present disclosure pertains may make various modifications and variations without departing from the spirit of the present disclosure.

Therefore, the example embodiments disclosed in the present disclosure are not intended to limit technical ideas of the present disclosure, but to explain them, and the scope of technical ideas of the present disclosure is not necessarily limited by these example embodiments. The protection range of the present disclosure can be interpreted by the claims below, and technical ideas within the equivalent range(s) can be interpreted as being included in the scope of the present disclosure.

What is claimed is:

1. A hydrogen tank temperature control apparatus comprising:
an air guide between a stack cooling module configured to cool a fuel cell stack and one or more hydrogen tanks;
a processor configured to control a temperature of the one or more hydrogen tanks by controlling one or more angles of the air guide; and
a storage configured to store data and algorithms driven by the processor.

2. The apparatus of claim 1, wherein the processor is configured to control the one or more angles of the air guide by using one of or any combination of an outside air temperature, an output of the fuel cell stack, and the temperature of the one or more hydrogen tanks.

3. The apparatus of claim 1, wherein the processor is configured to move horizontally air passing through the stack cooling module to the one or more hydrogen tanks by controlling an initial air guide to 0 degrees after a vehicle starts.

4. The apparatus of claim 1, wherein the processor is configured, in response to a case where an outside air temperature is lower than a first reference value, to control the air passing through the stack cooling module to flow upward into a first set of hydrogen tanks at a selected one or more angles by controlling the air guide.

5. The apparatus of claim 1, wherein the processor is configured to, in response to a case where an average temperature of a first set of the hydrogen tanks whose distance from the stack cooling module is greater than a first reference distance among the one or more hydrogen tanks is smaller than the average temperature of a second set of the hydrogen tanks whose distance from the stack cooling module is closer than the first reference distance among the one or more hydrogen tanks, control the one or more angles of the air guide to be smaller than a selected one or more angles.

6. The apparatus of claim 1, wherein the processor is configured to, in response to a case where an outside air temperature is lower than a first reference value, control the air guide by selected one or more angles to allow the air passing through the stack cooling module to flow into a first set of the hydrogen tanks that is farther from the stack cooling module among the one or more hydrogen tanks.

7. The apparatus of claim 6, wherein the processor is configured to compare an average temperature of the first set of the hydrogen tanks whose distance from the stack cooling module is greater than a first reference distance among the one or more hydrogen tanks with an average temperature of a second set of hydrogen tanks whose distance from the stack cooling module is closer than the first reference distance among the one or more hydrogen tanks.

8. The apparatus of claim 7, wherein the processor is configured to, in response to a case where the average temperature of the hydrogen tanks whose distance from the stack cooling module is greater than the first reference distance among the one or more hydrogen tanks is the same as the average temperature of the hydrogen tanks whose distance from the stack cooling module is closer than the first reference distance among the one or more hydrogen tanks, determine that temperatures of the one or more hydrogen tanks are uniformly controlled.

9. The apparatus of claim 7, wherein the processor is configured to, in response to a case where the average temperature of the hydrogen tanks whose distance from the stack cooling module is greater than the first reference distance among the one or more hydrogen tanks is greater than the average temperature of the hydrogen tanks whose distance from the stack cooling module is closer than the first reference distance among the one or more hydrogen tanks, control the one or more angles of the selected one or more angles of the air guide to be greater than the selected one or more angles.

10. The apparatus of claim 6, wherein the processor is configured to, in response to a case where the outside air temperature is higher than a second reference value, to block the air passing through the stack cooling module from flowing into the one or more hydrogen tanks by controlling the one or more angles of the air guide.

11. The apparatus of claim 10, wherein the first reference value is a temperature at which an output of the fuel cell stack is limited, and the second reference value is a temperature at which the fuel cell stack is shut down.

12. The apparatus of claim 1, wherein the processor is configured to determine whether an output of the fuel cell stack is greater than a first reference value, and in response to a case where the output of the fuel cell stack is greater than the first reference value, configured to block the air passing through the stack cooling module from flowing into the one or more hydrogen tanks by controlling the one or more angles of the air guide.

13. The apparatus of claim 12, wherein the processor is configured to, in response to a case where the output of the fuel cell stack is equal to or smaller than the first reference value, determine whether the output of the fuel cell stack is greater than a second reference value, wherein the second reference value is lower than the first reference value.

14. The apparatus of claim 13, wherein the processor is configured to, in response to a case where the output of the fuel cell stack is greater than the second reference value, compare an average temperature of a first set of the hydrogen tanks whose distance from the stack cooling module is greater than a first reference distance among the one or more hydrogen tanks with the average temperature of a second set of the hydrogen tanks whose distance from the stack cooling module is closer than the first reference distance among the one or more hydrogen tanks, to control the selected one or more angles of the air guide according to a comparison result thereof.

15. A system comprising:
a stack cooling module configured to cool a fuel cell stack;
one or more hydrogen tanks;
an air guide configured to introduce air passing through the stack cooling module into the one or more hydrogen tanks; and
a hydrogen tank temperature control apparatus configured to control a temperature of the one or more hydrogen tanks by controlling one or more angles of the air guide between the stack cooling module and the one or more hydrogen tanks.

16. The system of claim 15, wherein the air guide is provided between the stack cooling module and the one or more hydrogen tanks.

17. The system of claim 15, wherein the air guide comprises:
a body; and
a driver provided at a center of the body to drive rotation of the body.

18. The system of claim 15, wherein the hydrogen tank temperature control apparatus is configured to control the one or more angles of the air guide using an outside air temperature and an output of the fuel cell stack.

19. The system of claim 15, wherein the hydrogen tank temperature control apparatus is configured to, in response to a case where an outside air temperature is lower than a first reference value, control the air guide by selected one or more angles to allow the air passing through the stack cooling module to flow into a first hydrogen tank that is farther from the stack cooling module than other hydrogen tanks among the one or more hydrogen tanks.

20. A hydrogen tank temperature control method comprising:
determining an angle of an air guide between a stack cooling module configured to cool a fuel cell stack and one or more hydrogen tanks;
controlling the angle of the air guide according to the determined angle of the air guide; and
controlling a temperature of the one or more hydrogen tanks by allowing the air passing through the stack cooling module to flow into the one or more hydrogen tanks according to the determined angle of the air guide.
